(19) United States
(12) Patent Application Publication
(10) Pub. No.: US 2003/0061491 A1
(43) Pub. Date: Mar. 27, 2003

(54) System and method for the allocation of network storage

(75) Inventors: Thomas Jaskiewicz, Mason, NH (US); Milan M. Shetti, Somerville, MA (US)

Correspondence Address: LAHIVE & COCKFIELD, 28 STATE STREET, BOSTON, MA, 02109, US

(73) Assignee: Sun Microsystems, Inc., Palo Alto, CA

(21) Appl. No.: 09/960,673

(22) Filed: Sep. 21, 2001

(51) Int. Cl. G06F 15/173; H04K 1/00

(52) U.S. Cl. 713/182; 709/226

(57) ABSTRACT

The illustrative embodiment of the present invention provides a method for automating the allocation of network storage. The method of the present invention enables a system administrator or other authorized user to set policies for network storage. Available storage locations are dynamically located by attribute. The network storage policy is interpreted and applied to the available storage locations. By automating the storage allocation process, the storage policy is consistently applied without user intervention thus allowing a system administrator to devote more time to other network management responsibilities.

### FIELD OF THE INVENTION

The illustrative embodiment of the present invention relates generally to network storage and more particularly to dynamic allocation of network storage.

### Background

Network storage systems typically include storage devices situated at different locations. The storage devices are typically located remotely from the sources of data being stored on the storage devices. In many conventional network storage systems, the storage devices are magnetic disk drives configured into a RAID system. RAID is an acronym for Redundant Array of Inexpensive/Independent Disks.

Network storage allocations involve the assigning or matching of a storage location with a storage owner. A “storage owner” is a process or device which has permission to write or read data to and from a storage location. Typically the allocation of storage is done manually by a system administrator for the network. The system administrator is the person responsible for overseeing administration of the network. The allocation involves the system administrator directing a storage operation or making certain storage locations are available for programmatic storage. For example, the storage allocation may be performed by the system administrator requiring a network device to back up data periodically to a particular RAID set. Alternatively, the system administrator may select certain storage locations and make them available to be utilized by processors and devices on a first come first served basis. The allocation may result from the system administrator directly entering commands on a keyboard, or the allocation may be the result of the system administrator initiating a program which performs a backup of data on particular devices programmatically. Unfortunately, this sort of manual storage allocation requires increasing amounts of system administrator time as the amount of network storage available to be allocated increases. The sheer size of some current RAID systems, such as those with terabytes of available storage, makes the process of a system administrator manually allocating network storage increasingly inefficient. Moreover, this process is subject to human error.

### SUMMARY OF THE INVENTION

The illustrative embodiment of the present invention provides a method for automating the management of allocation of network storage. The illustrative embodiment enables a system administrator or other authorized user to set policies for network storage that are automatically implemented by software. Available storage locations are dynamically located. The network storage policy is interpreted and applied to the available storage locations. By automating the storage allocation process, the storage policy is applied consistently without system administrator participation being required, thus allowing a system administrator to devote more time to other network management responsibilities.

In one embodiment of the present invention, multiple storage locations are interfaced with a network. Also interfaced with the network is a software facility capable of identifying and allocating to owners available storage locations based on attributes possessed by the storage locations. The software facility receives a network storage policy with attribute requirements from an authorized user such as a systems administrator. The software facility programmatically applies the network storage policy in storage allocation decisions by matching the attribute requirements of the storage policy with identified attributes of the storage locations.

In an alternate embodiment of the present invention a host electronic device with a software facility is interfaced with a network. Also interfaced with the network are multiple devices with storage locations. The software facility dynamically locates available and non-allocated storage locations on the network. The available storage locations are identified by attributes. The software facility allocates the available storage locations in response to requests for storage. The request for storage includes attributes which are matched to the attributes of the network storage locations. Once allocated to a process or device, the process or device has the right to read and write data directly to and from the allocated storage location.

In another embodiment of the present invention a host electronic device is interfaced with the network. A software facility is also interfaced with the network at a location remote from the host electronic device. The network includes a plurality of devices with storage locations. The storage locations are identified by attribute by the software facility. The method of the present invention then allocates storage locations to owners on the network based on the attributes of the storage locations.

### BRIEF DESCRIPTION OF THE DRAWING

FIG. 1 is a block diagram of an environment suitable for practicing an illustrative embodiment of the present invention;

FIG. 2 is a block diagram of an alternate environment suitable for practicing an illustrative embodiment of the present invention;

FIG. 3 is a flow chart of the sequence of steps followed by the method of the present invention which is used to detect and allocate storage locations;

FIG. 4 is a block diagram depicting the list of storage devices and associated storage attributes in an illustrative embodiment of the present invention;

FIG. 5A is a block diagram of storage pools created by the method of the present invention; and

FIG. 5B is a block diagram of the storage pools of FIG. 5A at a later time.

### DETAILED DESCRIPTION

The illustrative embodiment of the present invention enables a system administrator to set a network policy for storage allocation. The method of the present invention dynamically identifies network storage locations by attribute and matches storage locations with processes and devices requiring network storage with certain attributes. An attribute is a characteristic that can be used to distinguish one device from another. For example an attribute for a magnetic disk drive is the size of the storage medium. Other attributes for a magnetic disk drive include its location and data access speed. The administrator may specify network wide minimum attributes for all network storage, or the system administrator may provide different storage policies for different processes and devices. The implementation of the network storage policy may be completely automated. Alternatively, the system administrator may manually allocate network storage for particular storage operations while automating the remainder of the storage operations.

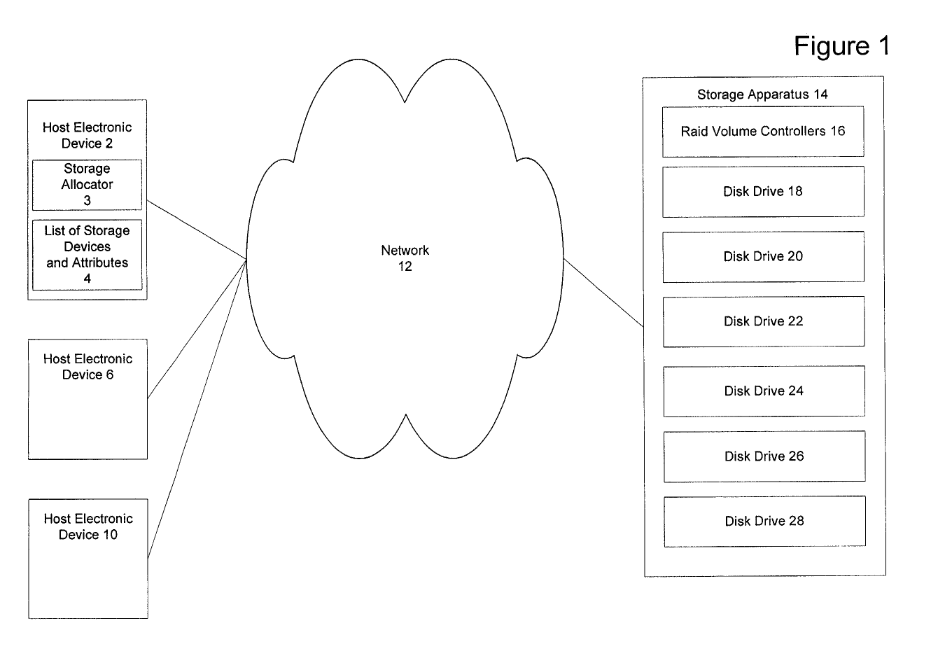

FIG. 1 depicts an environment suitable for practicing the illustrative embodiment of the present invention. A host electronic device 2 is interfaced with a network 12. A host electronic device 2 is a system containing data which is typically accessed by a user from a remote location. Examples of host electronic devices 2 with storage needs are mail servers and web servers. The host electronic device 2 includes a software facility for allocating network storage, referred to herein as a “storage allocator” 3. Also located on the host electronic device 2 is a list of storage devices and their associated attributes 4. Additional host electronic devices 6 and 10 are also interfaced with the network 12. A storage apparatus 14, such as a RAID system, is also interfaced with the network 12. The storage apparatus 14 includes a RAID volume controller 16 and a plurality of magnetic disk drives for storage 18, 20, 22, 24, 26, and 28. The storage allocator 3 may specify that the host electronic devices 2, 6 and 10 back up all data on RAID sets with specified attributes controlled by the RAID volume controller 16 on the storage apparatus 14. The various mechanisms used by the storage allocator 3 to identify and allocate storage locations are described in more detail below.

One of the mechanisms used by the storage allocator 3 to allocate network storage is the use of the Service Location Protocol (SLP). SLP is a protocol established by the Internet Engineering Task Force (IETF) that simplifies the discovery of network resources. The protocol utilizes the concept of User Agents, Service Agents and Directory Agents. Applications running on a computer are represented by User Agents which understand the service and resource needs of the application. In the case of the present invention, the storage allocator 3 may have a User Agent. Network devices, such as storage devices, are each represented by a Service Agent. Some networks have Directory Agents. The Service Agent of an available device multicasts a request message for any Directory Agents on the network to make contact. If any Directory Agents respond, the Service Agent unicasts a registration message to each responding Directory Agent. The registration message includes the type of device the Service Agent is representing, the device's attributes, and the device's Uniform Resource Locator (URL) address. When a User Agent needs a particular service, it sends out a service request which includes both the type of service and attributes desired. If the network possesses a Directory Agent, the Directory Agent responds with a list of eligible devices and the devices' Uniform Resource Locators (URLs). If there is no Directory Agent on the network, the User Agent multicasts its service request on the network and the Service Agents for devices whose attributes match those requested respond directly to the User Agent. By using SLP, the storage allocator 3 may be kept apprised of changing network storage conditions.

Another mechanism that may be used to determine available storage locations is the use of JIRO™ technology, available from Sun Microsystems, Inc. of Palo Alto, Calif. A JIRO™ enabled device broadcasts a JIRO™ event announcing the presence of the device on the network upon first being attached to the network. JIRO™ technology is explained in detail at www.jiro.org. The event message includes a description of the device attributes. A JIRO™ “bean”(a “bean” is a piece of software code constructed from a reusable code library) previously deployed on the network by the system administrator notes the presence of the storage device and informs the storage allocator 3 of the identity and attributes of the storage device. Those skilled in the art will recognize that the use of SLP and JIRO™ technology to track available network storage devices are illustrative examples of methods used in keeping track of network storage devices, but are not the exclusive methods available within the scope of the present invention.

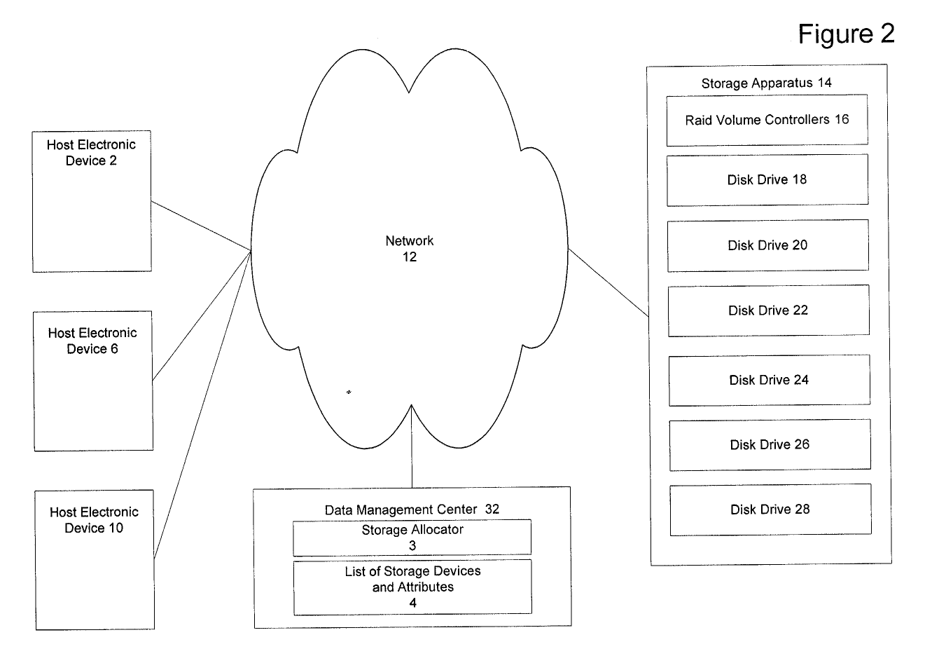

FIG. 2 depicts an alternate environment suitable for practicing an illustrative embodiment of the present invention. Host electronic devices 2, 6, and 10 are interfaced with a network 12. Also interfaced with the network 12 is a data management center 32 upon which the storage allocator 3 resides. Also located on the data management center 32 is a list of storage devices and associated attributes 4. The data management center 32 is a networked device providing data services such as “point in time copying”. “Point in time copying” allows a volume of data to be copied at a particular time, a snapshot of everchanging data, rather than copying the data when the volume is changed. The network 12 is also interfaced with a storage apparatus 14, (a RAID system). The storage apparatus 14 includes RAID volume controller 16 and magnetic disk drives 18, 20, 22, 24, 26, and 28. The method of the present invention enables the storage allocator 3 and the list of storage devices and associated attributes 4 to be located anywhere on the network.

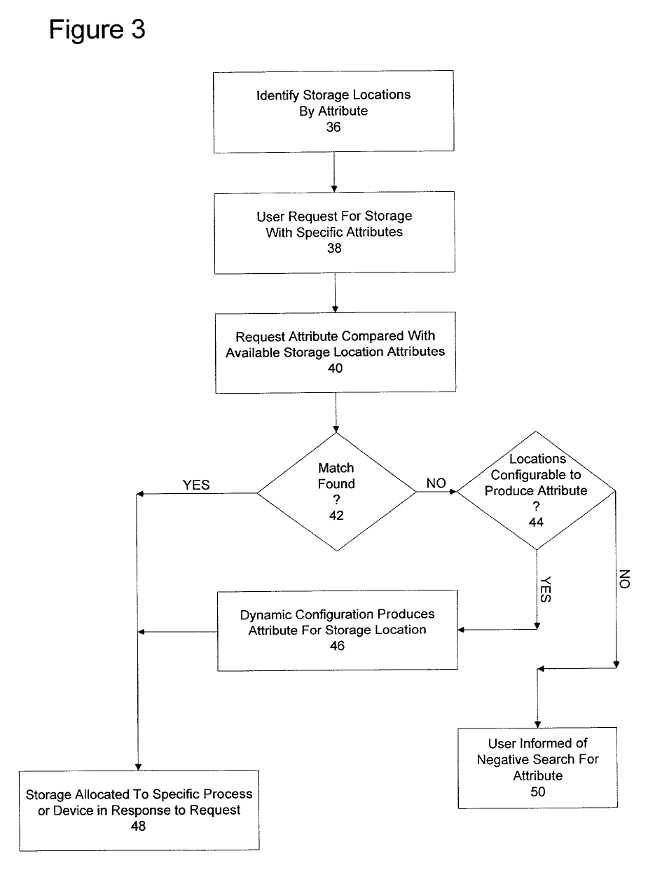

The method of the present invention involves first identifying attributes of a storage location and then allocating a storage location to an owner based upon one or more of the storage location attributes. FIG. 3 is a flow chart of the steps followed by an embodiment of the present invention to identify and allocate storage locations. The storage allocator 3 first identifies available storage locations by attribute (step 36). As noted, two ways of identifying available storage locations are through the use of SLP or as the result of notification of a JIRO™ event. Once the storage location has been identified, the storage allocator 3 records the attributes of the storage location. The attributes may be recorded at any storage location on the network which is accessible to the storage allocator 3. An authorized user, such as a system administrator, requests storage from the storage allocator 3 (step 38). The user's request includes storage location attributes desired by the user. The request may be in the form of a specific request from a particular device or process, or the request may be part of an automated network wide storage policy set by a system administrator. The policy may apply to the entire network or to only specific portions of the network. Alternatively, the network policy may apply to all devices and processes on the network or only a portion of the devices and processes on the network. The network storage policy may be input into the storage allocator 3 in a number of ways. The systems administrator may select certain storage attributes to be applied to the network from available choices in pull down menus. Alternatively, the storage allocator 3 may accept input text instructions which are parsed to establish attributes to be applied to network storage operations. Attributes which are input into the storage allocator 3 are stored as requirements for selected storage operations. Those skilled in the art will recognize that there are multiple ways of inputting storage attribute parameters into the storage allocator 3 that are within the scope of the current invention.

After a storage request is received, the requested storage attributes are compared with the attributes of the available storage locations (step 40). A determination is made as to whether there is a match based on the comparison (step 42). If a match of the requested storage attributes is found in an available storage location, the storage location is allocated to a specific process or device in response to the request (step 48). If a match between the requested attribute and the attributes in the available storage locations is not found (step 42), the storage allocator 3 determines whether or not the requested attribute may be dynamically configured using attributes of non-matching network storage locations (step 44). The storage allocator 3 consults the recorded attributes of identified storage locations to determine whether the attributes provide sufficient raw material susceptible of configuration into a storage location with the requested attribute. Those skilled in the art will recognize that some attributes, such as magnetic disk drive access time, are not dynamically configurable, but rather are either present or not present. If the attribute is dynamically configurable, such as by configuring available magnetic disk drives together into a RAID set with a given RAID level, the requested attribute is dynamically configured for a storage location (step 46). Once the attribute is dynamically configured for a storage location (step 46), the storage location is allocated to a specific process or device in response to the request (step 48). If the available storage locations do not have attributes matching the requested attributes (step 42), and the attribute is not dynamically configurable (step 44), the user is informed of the absence of available storage locations possessing the requested attributes (step 50).

The storage allocator 3 is responsible for managing the list of storage locations and associated storage attributes 4. The list of storage locations and associated storage attributes 4 includes a storage device identifier, usually a number, the location of the device on the network, the discoverable attributes of the storage device identified by the storage allocator 3, and any allocated owner of the storage device. The attributes may be recorded in memory anywhere on the network accessible to the storage allocator 3. The attributes may be recorded in any sort of data structure accessible by the storage allocator 3. For example, the list of storage locations and associated storage attributes 4 may be saved as a linked list. Alternatively, the list of storage locations and associated storage attributes 4 may be saved as a table of pointers to records.

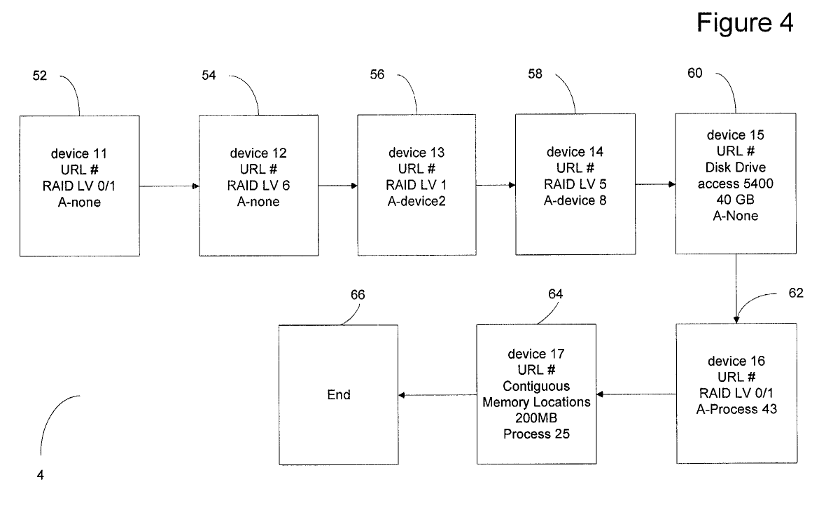

FIG. 4 depicts in more detail the list of storage locations and associated attributes 4 which is maintained by the storage allocator 3. The list of storage locations and associated attributes 4 is implemented as a linked list in the illustrative embodiment of FIG. 4. The list is comprised of nodes connected by pointers. Each node in the list includes a record with fields for the storage device ID #, the location of the storage location expressed as an URL, any discovered storage attributes for the storage location, and notice of any allocation of the storage device. As each storage location is identified by the storage allocator 3, a new node is added to the list. When a node is allocated or de-allocated, the record for the node is updated. Thus, node 52 includes a record for a storage location with a device ID 11. The record for device ID 11 indicates the device location with an URL for the device. The record also indicates that the device ID 11 is a RAID set with level 0/1 protection and that it is unallocated. A pointer from node 52 points to node 54, the record for the next storage location in the list. Node 54 has a unique device ID and URL (as do all of the storage devices) and indicates that it is a RAID set with a different RAID level. The record for node 56 indicates that it has been allocated to device 2. Accordingly, device 2 has permission to write and read data to and from the storage location with a device ID of 13. The next record, node 58 has a different RAID level and has been allocated to a different device. Node 60 contains a record for an unallocated magnetic disk drive with device ID 15. The storage allocator 3 has identified that the disk drive has storage attributes of disk access speed of 5400 and available storage of 40 Gigabytes. The device is unallocated. The next node 62 in the linked list of records and associated storage attributes 4 is for a storage location with device ID 16 that has been allocated to a process 43. Software processes may be assigned ownership of a storage location in the illustrative embodiments of the present invention. Node 64 is the record for a storage location with device ID 17 that is composed of logically contiguous memory locations. The memory locations may be on different mediums and accessed through a software volume controller, in which case the location in the record gives the location of the software volume controller rather than the URL of a physical device. The record for the storage location with device ID 17 indicates that 200 Megabytes have been assigned to a process ID 25. The list ends in an empty node 66. Those skilled in the art will recognize that the implementation of the list of storage devices and associated storage attributes may be made as a table of pointers to device records rather than as a linked list. Other data structures may be substituted for a linked list or table of pointers without departing from the scope of the current invention.

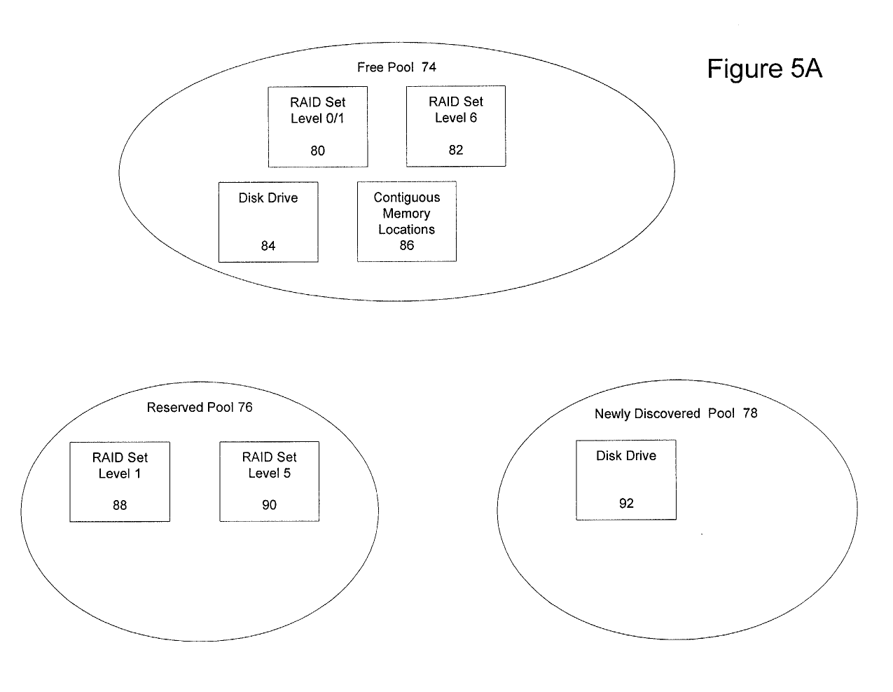

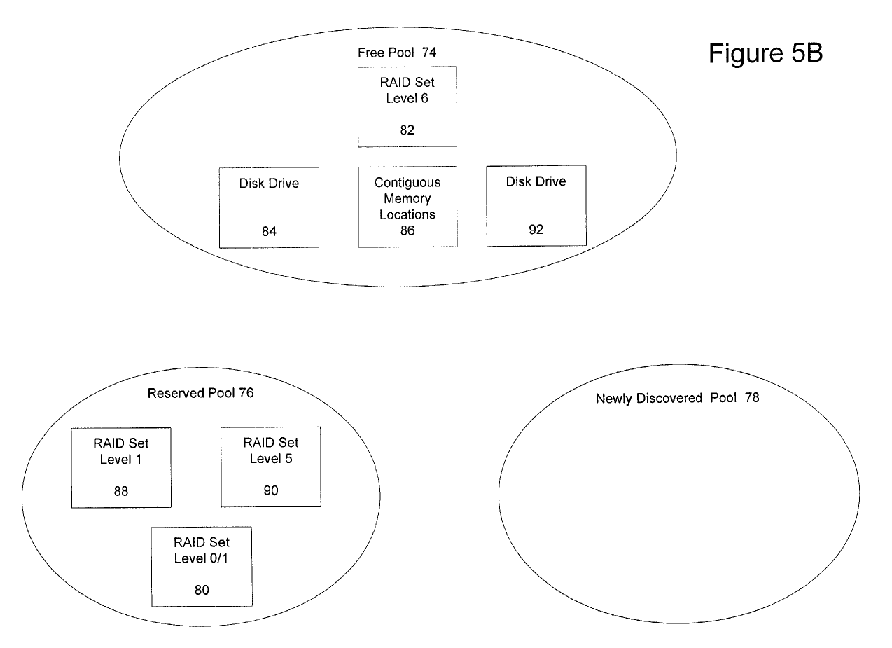

In one embodiment of the present invention, available storage locations are assigned to storage pools. The storage pools are groupings of storage locations. The storage allocator 3 utilizes the information contained in the list of storage locations and associated storage attributes 4 to perform the grouping of storage locations into the storage pools. FIG. 5A depicts a block diagram of the storage pools utilized in an example case. The storage allocator 3 groups identified network storage into three pools in the example of FIG. 5A. The storage allocator 3 groups network storage locations into a free pool 74, a reserve pool 76, and a newly discovered pool 78. The free pool 74 includes network storage locations identified by attributes that are available to be allocated to requesting processes or devices. The storage locations are said to be unallocated since they have not been allocated to an owner. The free pool 74 includes a RAID set with RAID level 0/1 protection 80, a RAID set with RAID level 6 protection 82, a magnetic disk drive 84, and logically adjacent memory locations 86. The logically adjacent memory locations 86 may be located on more than one device and are controlled by a software volume controller. The method of the present invention also includes a reserve pool 76. The reserve pool 76 is for network storage locations which have already been allocated to specific devices or processes or are being reserved for future use and which are not currently available to the storage allocator 3. The reserve pool 76 includes a RAID set with RAID level 1 protection 88, and a second RAID set with RAID level 5 protection 90. A third type of pool utilized by the method of the present invention is a newly discovered pool 78. The newly discovered pool 78 may include a magnetic disk drive 92 which notifies the storage allocator 3 of its presence and attributes through a JIRO™ event message. Those skilled in the art will recognize that the storage locations present in the different pools will vary as storage is allocated or becomes available.

The storage locations included in the three types of storage location pools are dynamic so that the storage locations in the respective pools may change over time. FIG. 5B depicts a block diagram of the storage pools of FIG. 5A at a later point in time. The free pool 74 of network storage locations still includes the RAID set with RAID level 6 protection 82, the magnetic disk drive 84, and logically adjacent memory locations 86. The free pool 74 also includes the magnetic disk drive 92 which previously had been in the newly discovered pool 78. The magnetic disk drive 92 has been assigned to the free pool by the storage allocator 3. The RAID set with RAID level 0/1 protection 80, which formerly was in the free pool 74, has been assigned to the reserve pool 76 by the storage allocator 3 which has allocated the RAID set with RAID level 0/1 protection. Accordingly, the RAID set with RAID level 0/1 protection 80 is no longer available for allocation. The newly discovered pool 78 is empty.

The storage allocator 3 may dynamically reconfigure the storage devices in the free pool 74 to provide a requested attribute. For example, the storage allocator 3 may receive a request for a RAID set with a specified level of RAID protection. When the storage allocator receives a request for storage, the free pool is checked to see if a RAID set with the specified level of RAID protection is available. In the event there is not an available RAID set with a specified level of RAID protection, the method of the present invention attempts to provide a RAID set possessing the requested attribute. The storage allocator may reconfigure the two magnetic disk drives 84 and 92 in the free pool 74 into the requested RAID set. The request may call for the RAID set to be created for future use in which case the new RAID set would remain in the free pool 74. Alternatively, the storage allocator 3 may request a RAID set to be created and utilized immediately, in which case the newly created RAID set is allocated and transferred to the reserved pool 76.

It will thus be seen that the invention attains the objects made apparent from the preceding description. Since certain changes may be made without departing from the scope of the present invention, it is intended that all matter contained in the above description or shown in the accompanying drawings be interpreted as illustrative and not in a literal sense. Practitioners of the art will realize that the system configurations depicted and described herein are examples of multiple possible system configurations that fall within the scope of the current invention. Likewise, the types of storage devices noted in the drawings and description are examples and not the exclusive types of storage devices which may be employed within the scope of the present invention.

We claim:

1. In a network with a plurality of storage locations having attributes, said attributes being characteristics of said storage locations, a method, comprising the steps of:
providing a software facility interfaced with said network for identifying and allocating said storage locations to a storage owner based on the attributes of said storage locations;
receiving with said software facility a network storage policy from an authorized user, said authorized user having authority to control access to said storage locations on said network, said storage policy including attribute requirements for at least one of said storage locations; and
programmatically applying said storage policy to storage decisions on said network using said software facility, said storage decisions determining where data on said network is stored.

2. The method of claim 1 wherein said authorized user selects said storage location attributes in said network policy from a list of storage location attributes.

3. The method of claim 1, comprising the further step of:
configuring storage locations to provide specified attributes pursuant to said network storage policy.

4. In a network, said network interfaced with a host electronic device and including a plurality of devices with storage locations located thereon, a method comprising the steps of:
providing a software facility interfaced with said network;
using said software facility to identify by attribute available storage locations on said plurality of devices; and
using said software facility to perform allocation of said available storage locations based on said available storage location attributes, said allocation being the association of a storage location with an owner, said owner having permission to write data to said storage location and read data from said storage location.

5. The method of claim 4 wherein a storage location is allocated based on matching a requested storage location attribute with the storage location attribute identified by said software facility.

6. The method of claim 4 wherein a selected one of said storage locations is allocated based on matching a requested storage location attribute with an attribute of a storage location dynamically configured by said software facility.

7. The method of claim 4, comprising the further step of:
placing an unallocated storage location into a pool of storage locations available to said software facility.

8. The method of claim 7 comprising the further step of:
placing a storage location into a pool of storage locations unavailable to said software facility.

9. The method of claim 7 comprising the further step of:
placing newly discovered unallocated storage locations into a pool of storage locations awaiting further action by said software facility, said storage locations not having been previously identified by said software facility.

10. The method of claim 4 wherein said software facility uses the Service Location Protocol (SLP) to identify available devices attached to said network.

11. The method of claim 4 wherein at least one of said plurality of devices interfaced with said network with storage locations thereon is a RAID (Redundant Array of Inexpensive/Independent Disks) set.

12. The method of claim 4 wherein a storage location with a specified attribute is provided by dynamically configuring a storage location in response to a request from a user of said host electronic device interfaced with said network.

13. The method of claim 4, comprising the further steps of:
setting a network policy for data storage, said policy including storage location attributes requested by an authorized user, said authorized user having authority to make network storage decisions; and
configuring storage locations to provide specified attributes pursuant to said network policy.

14. The method of claim 4 wherein said software facility is located on said host electronic device.

15. In a network with a plurality of storage locations having attributes, said attributes being characteristics of said storage locations, a medium holding computer-executable instructions for a method, comprising the steps of:
providing a software facility interfaced with said network for identifying and allocating said storage locations based on the attributes of said storage locations, said allocation being the association of a storage location with an owner, said owner having permission to write data to said storage location and read data from said storage location;
receiving with said software facility a network storage policy from an authorized user, said authorized user having authority to make storage decisions on said network, said storage policy including attribute requirements for storage locations; and
programmatically applying said storage policy to storage decisions on said network using said software facility, said storage decisions determining where data on said network is stored.

16. The method of claim 15 wherein said authorized user selects said storage location attributes in said network policy from a list of storage location attributes.

17. The method of claim 15, comprising the further step of:
automatically configuring storage locations to provide specified attributes pursuant to said network storage policy.

18. In a network, an apparatus comprising:
a processor;
a record of a plurality of unallocated storage locations interfaced with said network, said storage locations identified by attributes; and
a software facility for allocating said unallocated storage locations to devices and processes interfaced with said network based on said attributes.

19. In a network with a plurality of interfaced devices with storage locations located thereon, a method comprising the steps of:
providing a software facility interfaced with said network;
using said software facility to identify by attribute available storage locations on said plurality of interfaced devices;
configuring said available storage locations to provide storage locations with new attributes; and
using said software facility to perform allocation of said storage locations with new attributes, said allocation being the association of a storage location with an owner, said owner having permission to write data to said storage location and read data from said storage location.

20. The method of claim 19, comprising the further steps of:
receiving a network storage policy from an authorized user interfaced with said network; and
programmatically applying said network storage policy in the configuring and allocation of said storage locations.

21. The method of claim 20 wherein a storage location is allocated based on matching a storage location attribute requested by said network storage policy with the storage location attribute of a storage location identified by said software facility.
